(19) United States
(12) Patent Application Publication
(10) Pub. No.: US 2025/0023362 A1
(43) Pub. Date: Jan. 16, 2025

(54) ELECTRIC VEHICLE AND ANTITHEFT SYSTEM OF SECONDARY BATTERY

(71) Applicant: SEMICONDUCTOR ENERGY LABORATORY CO., LTD., Atsugi-shi, Kanagawa-ken (JP)

(72) Inventors: Takeshi OSADA, Isehara, Kanagawa (JP); Tetsuya KAKEHATA, Isehara, Kanagawa (JP); Yosuke TSUKAMOTO, Atsugi, Kanagawa (JP); Shigeru ONOYA, Isehara, Kanagawa (JP); Noboru INOUE, Atsugi, Kanagawa (JP); Shunpei YAMAZAKI, Setagaya, Tokyo (JP)

(21) Appl. No.: 18/711,808

(22) PCT Filed: Nov. 28, 2022
(86) PCT No.: PCT/IB2022/061454

§ 371 Date: May 20, 2024

(30) Foreign Application Priority Data
Dec. 10, 2021 (JP) 2021-200512

(51) Int. Cl. H02J 7/00; B60R 25/045; B62J 43/13; B62J 43/16; H04L 9/40; H04W 12/06

(52) U.S. Cl. CPC H02J 7/00045; B60R 25/045; B62J 43/13; B62J 43/16; H04L 63/0869; H04W 12/06

(57) ABSTRACT

An electric vehicle and a system that easily recognize theft of a secondary battery of an electric vehicle typified by an electrically assisted bicycle and prevent the theft are provided. To prevent the theft of a secondary battery that can be detached from an electric vehicle typified by an electrically assisted bicycle or an electric motorcycle, mutual authentication between an electric vehicle body unit and a secondary battery unit is performed. The secondary battery unit at least includes a first memory portion storing first identification information, an authentication portion, and a wireless communication portion.

### TECHNICAL FIELD

The present invention relates to an electric vehicle and an antitheft system thereof.

One embodiment of the present invention relates to an object or a manufacturing method. Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that semiconductor devices in this specification mean all devices that can function by utilizing semiconductor characteristics, and an electro-optical device, a semiconductor circuit, and an electronic device are all semiconductor devices.

Note that power storage devices in this specification refer to any elements and devices having a function of storing power. For example, a power storage device (also referred to as a secondary battery) such as a lithium-ion secondary battery, a lithium-ion capacitor, and an electric double layer capacitor are included.

### BACKGROUND ART

In recent years, lithium-ion secondary batteries, lithium-ion capacitors, air batteries, or a variety of power storage devices have been actively developed. In particular, lithium-ion secondary batteries with high output and high energy density are used in portable information terminals typified by mobile phones, smartphones, and laptop computers, portable music players, digital cameras, medical equipment, next-generation clean energy vehicles typified by hybrid electric vehicles (HVs), electric vehicles (EVs), and plug-in hybrid electric vehicles (PHVs), and the like; demand for the lithium-ion secondary batteries has rapidly grown with the development of the semiconductor industry and the lithium-ion secondary batteries are essential for today's information society as rechargeable energy supply sources.

An electrically assisted bicycle or an electric motorcycle (also referred to as an electric motor scooter) has been equipped with a lithium-ion secondary battery.

Such an electric vehicle employs a secondary battery capable of being attached to and detached from the electric vehicle, and the battery is detached when charged.

FIG. 13 illustrates an example of a block diagram of a conventional electric vehicle. An electric vehicle body unit 1220 is provided with the production number label or mark of a vehicle body or the production number label or mark of an operation portion for quality management. An operation portion 1207 includes a display portion 1208 and a power switch 1209, and when the power switch 1209 is pressed by a user, electric power from a secondary battery 1200 is supplied to an electric motor portion 1201 through a charge/discharge control portion 1203. A secondary battery unit 1210 is also provided with its production number label. In the case of an electrically assisted bicycle within the country, the electric vehicle body unit 1220 may be registered for crime prevention, in which case the production number of the vehicle body is used to be protected from theft; however, the production number of the secondary battery unit 1210 is merely an individual identification number for quality management.

Patent Document 1 discloses a high-security power storage system using a neural network. In the power storage system disclosed in Patent Document 1, operation of a storage battery can be stopped.

### Reference

### Patent Document

[Patent Document 1] Japanese Published Patent Application No. 2019-023853

### SUMMARY OF THE INVENTION

### Problems to be Solved by the Invention

A secondary battery that can be detached from an electric vehicle typified by an electrically assisted bicycle or an electric motorcycle has suffered from the problem of theft and resale. A secondary battery is consumable and its performance is damaged by deterioration. Although such a secondary battery needs to be replaced after use for years and is expensive accordingly, replacement of only secondary battery is better than replacement of the whole electric vehicle, so that there is demand for only the secondary battery. Moreover, the secondary battery is just locked with a fragile physical key and can be easily detached by breakage of the key. Furthermore, a theft causes a huge loss.

By trading on the Internet, only secondary batteries can be bought and sold at present, thieves can easily turn them into money. In addition, secondary batteries can be resold by thieves without use. Moreover, secondary batteries of electrically assisted bicycles are compatible with each other and can be freely hooked up to electric vehicles of different models. Thus, a secondary battery is available to a user who has bought it on the Internet without knowing that it is a stolen article.

An object of one embodiment of the present invention is to provide an electric vehicle and a system that easily recognize theft of a secondary battery of an electric vehicle typified by an electrically assisted bicycle and prevent the theft.

### Means for Solving the Problems

To prevent the theft of a secondary battery that can be detached from an electric vehicle typified by an electrically assisted bicycle or an electric motorcycle, mutual authentication between an electric vehicle body unit and a secondary battery unit is performed.

The secondary battery unit at least includes a first memory portion storing first identification information, an authentication portion, and a wireless communication portion. The electric vehicle body unit includes a second memory portion storing second identification information. Only when the authentication portion of the secondary battery unit can identify it as the first identification information, a normal mode is set, where electric power is supplied from the secondary battery to an electric motor portion.

In the case of a failure in authentication by the authentication portion of the secondary battery unit, the secondary battery is deemed to be stolen and the process moves to a theft mode, where warning is displayed on a display of the electric vehicle body unit or a lamp of the secondary battery unit is turned on. Alternatively, the secondary battery is deemed to have an abnormality and the process moves to an abnormality mode, where warning may be displayed on the display of the electric vehicle body unit or the lamp of the secondary battery unit may be turned on.

In the case of a failure in authentication by the authentication portion of the secondary battery unit, the stolen secondary battery may be in an overdischarge state with the lamp kept on so that the secondary battery is non-functional. Making the stolen secondary battery non-functional can reduce theft due to resale.

A structure of the invention disclosed in this specification is an electric vehicle including an electric vehicle body unit including an electric motor portion and a secondary battery unit capable of being attached to and detached from the electric vehicle body unit. The secondary battery unit includes a first memory portion storing first identification information, and the electric vehicle body unit includes a second memory portion storing second identification information. The secondary battery unit includes an authentication portion collating the first identification information and the second identification information, and a wireless communication portion receiving the first identification information and the second identification information.

In the above structure, the secondary battery unit includes a secondary battery and a charge/discharge control portion electrically connected to the secondary battery, and electric power is supplied to the electric motor portion on the basis of a signal from the authentication portion.

In the above structure, the first identification information and the second identification information are transmitted from an information terminal of a user to the wireless communication portion. The wireless communication portion may be provided not only in the secondary battery unit but also in the electric vehicle body unit.

A server device can be used to manage the identification number of the electric vehicle body unit or the identification number of the secondary battery unit, thereby determining whether the secondary battery is a stolen article.

A server device can also be used to achieve an antitheft system of a secondary battery.

A structure of an antitheft system of a secondary battery disclosed in this specification includes an electric vehicle body unit including an electric motor portion, a secondary battery unit capable of being attached to and detached from the electric vehicle body unit, and a server device that generates, registers, and manages first identification information and second identification information. The secondary battery unit includes a first memory portion storing the first identification information, a wireless communication portion that can communicate with an information terminal of a user, and an authentication portion. The electric vehicle body unit includes a second memory portion storing the second identification information. After collating the first identification information and the second identification information, output from the secondary battery unit to the electric motor portion is allowed when authentication by the authentication portion succeeds, or output from the secondary battery unit to the electric motor portion is stopped when the authentication fails.

In the above structure of the system, the server device generates first identification information and second identification information. Specifically, on the basis of the production number of the electric vehicle body unit, the production number of the secondary battery unit, and user information identifying an individual who is the user, the server device generates the identification number (first identification information) serving as an encryption key and the identification number (second identification information) serving as an encryption key to that. Note that there is no limitation on the three pieces of data (the production number of the electric vehicle body unit, the production number of the secondary battery unit, and user information identifying an individual who is the user), on the basis of any one of the three pieces of data, the server device generates the identification number serving as an encryption key and the identification number serving as an encryption key to that. The identification numbers may be common data or different identification numbers.

Examples of the user information that can be used include numeral data obtained from an IC chip embedded in an ID card typified by a driver's license or an individual number card, and the phone number, mail address, or account name of an information terminal.

The identification number of an individual number card is the identification number of an individual registered in Japanese municipalities and refers to data composed of a 12 digit number among a plurality of pieces of data registered in an IC chip embedded in the individual number card. The antitheft system of a secondary battery disclosed in this specification is not limited to use in Japan, the social security number can be employed as the user information for use in the US. The individual ID number conforming to the regulations of each country can be employed as the user information.

An encryption key might be broken by a malicious outsider but it enables crime prevention meeting certain standards and is preferably used. An encryption key is also referred to as an encryption code and not limited to information the contents of which is prevented from leaking to an outsider, it may employ a combination of a given number or a symbol (including an alphabet), such as ID information.

Note that there is no limitation on whether the server device is within the country because it is sometimes placed abroad. It is determined that the present invention is used as long as the user is within the country and receives a service utilizing the present invention by downloading a program (application software) to be installed from the server device, part or the whole of which is even abroad. Furthermore, it is determined that the present invention is used by an outsider in the case where the outsider provides a service available to individual users though it is not a business.

In the above system, a state where the secondary battery is stolen is displayed or the secondary battery is made non-functional when the authentication fails.

### Effect of the Invention

The secondary battery unit capable of being attached to and detached from the electric vehicle body unit is provided with the authentication portion, thereby achieving antitheft. The secondary battery unit determined to be stolen by the authentication portion is brought into a non-functional state. The antitheft system using the authentication portion precludes the desire to steal the secondary battery unit, whereby an antitheft measure can be taken.

### BRIEF DESCRIPTION OF THE DRAWINGS

FIG. 1 is a block diagram illustrating one embodiment of the present invention.

FIG. 2 is an example of an authentication flow illustrating one embodiment of the present invention.

FIG. 3A and FIG. 3B are circuit diagrams of an antitheft system of a secondary battery of one embodiment of the present invention.

FIG. 4A and FIG. 4B are circuit diagrams of a charge/discharge control circuit.

FIG. 5 is a circuit diagram of a charge/discharge control circuit.

FIG. 6A illustrates an example of a cylindrical secondary battery, FIG. 6B illustrates an example of the cylindrical secondary battery, FIG. 6C illustrates an example of a plurality of cylindrical secondary batteries, and FIG. 6D illustrates an example of a battery management system including the plurality of cylindrical secondary batteries.

FIG. 7A and FIG. 7B are diagrams illustrating examples of a secondary battery, and FIG. 7C is a diagram illustrating the internal state of the secondary battery.

FIG. 8A to FIG. 8C are diagrams illustrating an example of a secondary battery.

FIG. 9A and FIG. 9B are external views of a secondary battery.

FIG. 10A to FIG. 10C are diagrams illustrating a method for fabricating a secondary battery.

FIG. 11A is a perspective view of a battery pack illustrating one embodiment of the present invention, and FIG. 11B is a block diagram of the battery pack.

FIG. 12A is a diagram illustrating an electric bicycle, FIG. 12B is a diagram illustrating a secondary battery of an electric bicycle, and FIG. 12C is a diagram illustrating an electric motorcycle.

FIG. 13 is a block diagram illustrating a conventional embodiment.

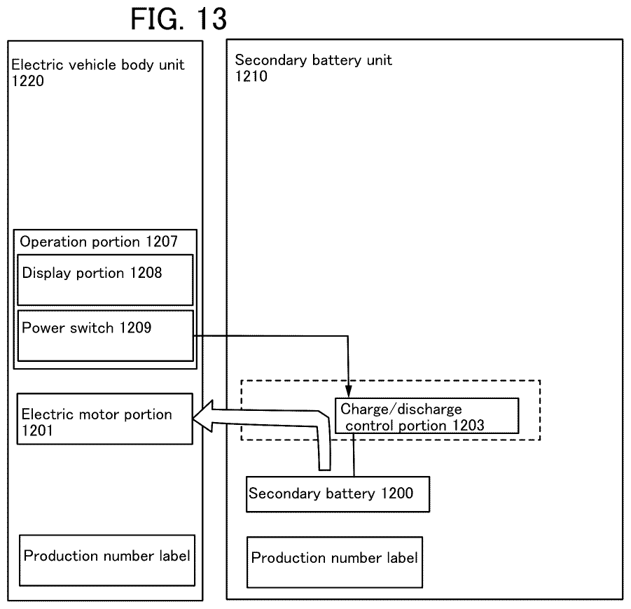

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the following embodiments.

### Embodiment 1

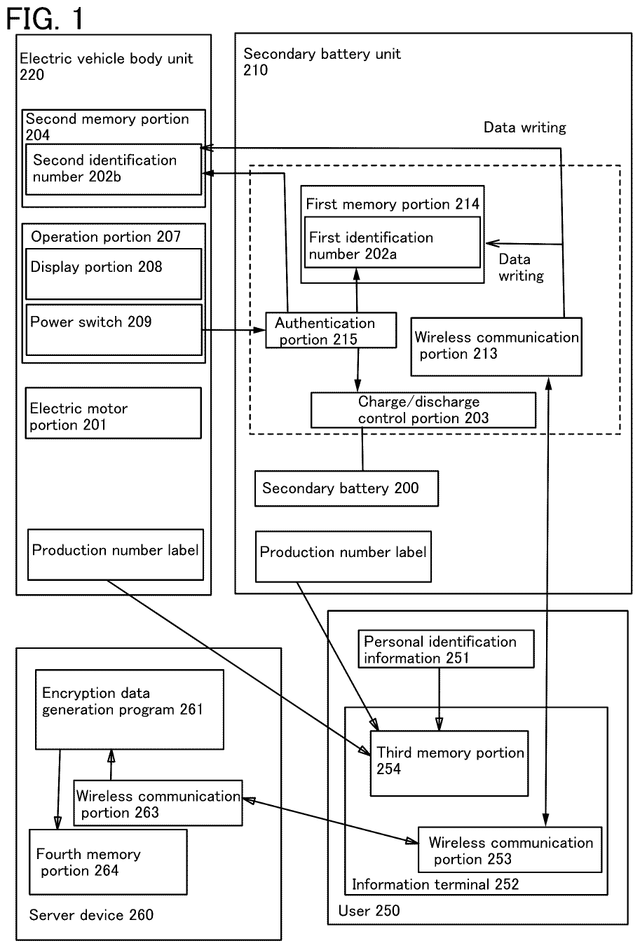

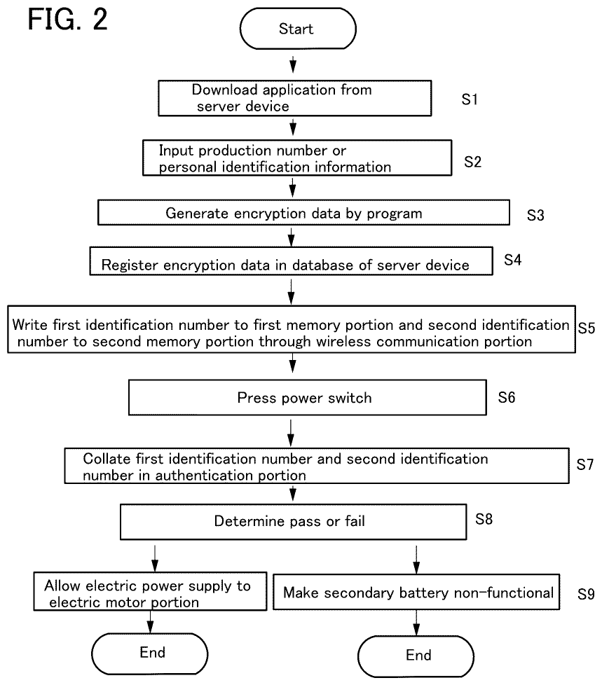

In this embodiment, an electric vehicle and an antitheft system are described with reference to FIG. 1 and FIG. 2. In the description of this embodiment, an electrically assisted bicycle is given as an example.

An electrically assisted bicycle is composed of an electric vehicle body unit 220 and an attachable and detachable secondary battery unit 210.

The secondary battery unit 210 includes an authentication portion 215, a wireless communication portion 213, and a first memory portion 214 in addition to a secondary battery 200 and a charge/discharge control portion 203. The charge/discharge control portion 203, the authentication portion 215, the wireless communication portion 213, and the first memory portion 214, which are surrounded by a dotted line in FIG. 1, form a circuit group, and ICs can also be provided over one IC substrate. The secondary battery unit 210 also has its identification number, or more specifically, a production number label or mark. A first identification number 202a is generated on the basis of this production number of the secondary battery unit 210, and the first memory portion 214 for storing it is included.

The electric vehicle body unit 220 includes an electric motor portion 201 and an operation portion 207. The electric vehicle body unit 220 also has its identification number, or more specifically, a production number label or mark. A second identification number 202b is generated on the basis of this production number of the electric vehicle body unit 220, and the second memory portion 204 for storing it is included. The second memory portion 204 may be included in the operation portion 207.

Next, FIG. 2 illustrates an example of an authentication flow in the antitheft system of the electrically assisted bicycle, which uses the first identification number 202a and the second identification number 202b used in the authentication portion 215 for antitheft.

First, a server device 260 illustrated in FIG. 1 includes an encryption data generation program 261 and a wireless communication portion 263 that enables interactive communication with a wireless communication portion 253 of an information terminal 252 possessed by a user 250. The information terminal 252 possessed by the user 250 is a personal computer, a smartphone, or a small portable information terminal (a watch-type information terminal) and includes a third memory portion 254 that records a variety of kinds of data.

By the user 250, application software (also referred to as an application) for authentication for the antitheft system of the electrically assisted bicycle is downloaded from the server device 260, through the wireless communication portion 253, into the third memory portion 254 of the information terminal 252. This step is Step S1 in FIG. 2.

Then, a production label of the electric vehicle body unit 220, a production label of the secondary battery unit 210, or personal identification information 251 of the user is read by the information terminal 252 or manually input by the user 250 and stored in the third memory portion 254. This step is Step S2 in FIG. 2. As the user's personal identification information 251, fingerprints, the number of the driver's license, or the number of the individual number card may be employed.

Then, on the basis of such data (one or more of the production label of the electric vehicle body unit 220, the production label of the secondary battery unit 210, and the user's personal identification information 251), a piece of encryption data is generated by the encryption data generation program 261 of the server device 260. This step is Step S3 in FIG. 2.

Then, the piece of encryption data is stored in a fourth memory portion 264 of the server device 260 and registered to function as a database corresponding to a plurality of the users 250. This step is Step S4 in FIG. 2.

Note that as long as the third memory portion 254 has sufficient capacity and the information terminal 252 includes a processing circuit with sufficient arithmetic performance, the encryption data generation program 261 of the server device 260 may be downloaded into the third memory portion 254 to allow the information terminal 252 to generate a piece of encryption data.

With the use of the information terminal 252, the user 250 records pieces of encryption data in the electric vehicle body unit 220 and the secondary battery unit 210 of the electrically assisted bicycle possessed by the user. The pieces of encryption data recorded may be the same or different. Since two secondary battery units 210 may be used in rotation for one electric vehicle body unit 220, the pieces of encryption data recorded are preferably different and associated to the respective units by the authentication portion 215. In that case, one electric vehicle body unit 220 is associated to a plurality of secondary battery units. Note that one secondary battery unit 210 can be authenticated only by the piece of encryption data of one electric vehicle body unit 220. Therefore the first memory portion 214 of the secondary battery unit 210 is preferably a write-once memory. In this embodiment, as the piece of encryption data, the first identification number 202a is written to the first memory portion 214 through the wireless communication portion 213. In addition, as the piece of encryption data, the second identification number 202b is written to the second memory portion 204 through the wireless communication portion 213. This step is Step S5 in FIG. 2.

Note that although an example in which the secondary battery unit 210 and the electric vehicle body unit 220 are connected to each other and data is written using one wireless communication portion 213 is described here, a wireless communication portion may be provided in the electric vehicle body unit 220. A Bluetooth (registered trademark) may be used as the wireless communication portion.

The secondary battery unit 210 and the electric vehicle body unit 220 store the respective identification numbers in the above manner, and are now ready for the use of the electrically assisted bicycle.

Next, the user 250 presses a power switch 209 of the operation portion 207 of the electric vehicle body unit 220 to use the electric motor portion 201 of the electrically assisted bicycle. This step is Step S6 in FIG. 2. The electrically assisted bicycle is a normal bicycle unless the user 250 presses the power switch 209; the strength of the user's legs is not assisted until the power switch 209 is pressed to start the electric motor portion 201. In the off state of the antitheft system, the secondary battery 200, which is a main battery, is electrically isolated from the operation portion 207 for low power consumption and safety.

In this embodiment, when the power switch 209 is pressed, the authentication portion 215 collates whether the first identification number 202a and the second identification number 202b are closely matched. This step is Step S7 in FIG. 2.

Then, the authentication portion 215 determines pass or fail; if authentication is succeeded, electric power supply to the electric motor portion 201 is allowed. This step is Step S8 in FIG. 2. Thus, when the power switch 209 of the operation portion 207 is pressed, display on the display portion 208 is kept during a certain period of time and electric power from the secondary battery 200 is supplied to the electric motor portion 201 on the basis of a signal from the authentication portion 215.

In the case of a failure in the authentication, the secondary battery is deemed to be stolen and the process moves to a theft mode, followed by an action of making the secondary battery in the user's electrically assisted bicycle non-functional. This step is Step S9 in FIG. 2. The action of making the secondary battery non-functional is at least preventing electric power supply to the electric motor portion 201 of the electrically assisted bicycle from the secondary battery.

In the theft mode, the secondary battery is made non-functional in the electric vehicle of the user where the secondary battery is set or a theft mark is displayed. Not only is the capacity level of the secondary battery unit 210 displayed, but also a theft display lamp may be turned on in the theft mode. Furthermore, in the theft mode, a warning sound may be generated from a speaker. The theft display lamp or the theft mode may be replaced with an abnormality display lamp or an abnormality mode. Needless to say, the stolen secondary battery is usable when set in the original authenticated electric vehicle before theft.

As the action of making the secondary battery non-functional in the electric vehicle of the user in the theft mode, a charge switch or a discharge switch is turned off in the charge/discharge control portion 203, for example. Alternatively, the secondary battery may be discharged using a cell balancing function of the charge/discharge control portion 203. Alternatively, the secondary battery may be discharged by continuously turning on the theft display lamp. In the case where a battery management system capable of regenerative charging is utilized, regenerative charging in the secondary battery is stopped.

Although the example of the electrically assisted bicycle is described in this embodiment, the present invention can also be applied to an electric motorcycle. In the usage pattern of the electrically assisted bicycle, the user 250 manually throws a power switch to use the electric motor portion while riding and hence authentication is performed whenever the power switch is thrown. By contrast, in an electric motorcycle, the electric motor portion is driven during riding and therefore authentication is performed before the start of running.

This embodiment can be freely combined with the other embodiments.

### Embodiment 2

This embodiment shows an example of the charge/discharge control portion 203 that is partly different from that in Embodiment 1. The charge/discharge control portion 203 can also be referred to as a battery management system.

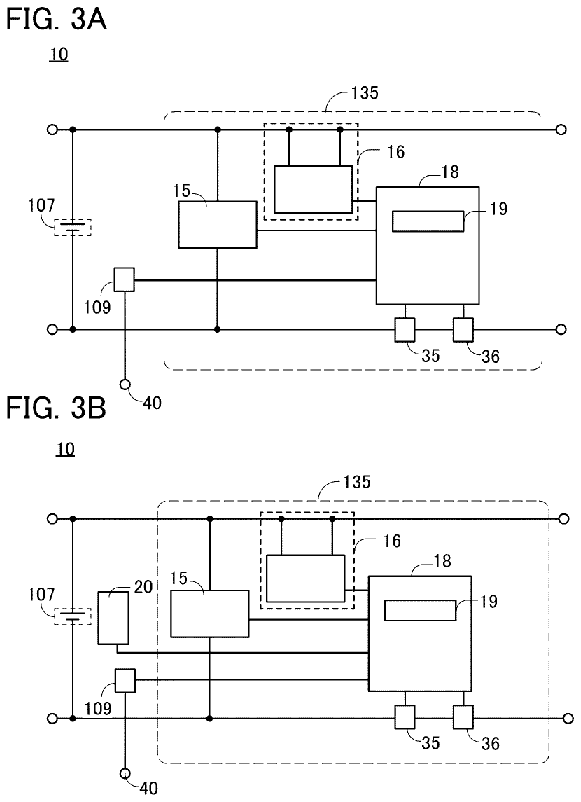

FIG. 3A illustrates an example of a battery management system 10 which is part of the antitheft system of the secondary battery of one embodiment of the present invention. The battery management system 10 includes a charge/discharge control circuit 135, a battery 107, and an authentication portion 109. The charge/discharge control circuit 135 is electrically connected to the battery 107. Specifically, the charge/discharge control circuit 135 is electrically connected to a positive electrode and a negative electrode of the battery 107. A positive electrode terminal such as a positive electrode lead or a positive electrode tab is provided in the battery 107 as the positive electrode in some cases. A negative electrode terminal such as a negative electrode lead or a negative electrode tab is provided in the battery 107 as a negative electrode in some cases. In such cases, the charge/discharge control circuit 135 is electrically connected to the positive electrode terminal and the negative electrode terminal. The authentication portion 109 includes a memory. The authentication portion 109 has a function of collating a recognition number of an electric vehicle body and a recognition number of the battery 107. Specifically, the authentication portion 109 has a function of comparing the piece of encryption data (corresponding to the second identification number 202b described in Embodiment 1) stored in the memory in the electric vehicle body and the piece of encryption data corresponding to the production number of the battery (corresponding to the first identification number 202a described in Embodiment 1). The authentication portion 109 is electrically connected to the charge/discharge control circuit 135. The authentication portion 109 obtains the piece of encryption data stored in the memory of the electric vehicle body from the terminal 40. The terminal 40 is electrically connected to a read circuit of the memory in the electric vehicle body.

The charge/discharge control circuit 135 illustrated in FIG. 3A includes at least a voltage measurement circuit 15, a current measurement circuit 16, and a control circuit 18. Furthermore, the charge/discharge control circuit 135 includes a first switch 35 and a second switch 36 electrically connected to the control circuit 18. The first switch 35 functions so as to stop charge in overcharge, and the second switch 36 functions so as to stop discharge in overdischarge. Furthermore, using the first switch 35, charging to the battery 107 can be stopped on the basis of a signal from the authentication portion 109.

Although not illustrated here, the authentication portion 109 includes, in addition to the memory, a rewriting circuit or a reading circuit of data for the memory and includes a wireless communication portion that can communicate with a user's information terminal. The user can write data from the information terminal to the memory through the wireless communication portion. In the case where data is written to the memory through the wireless communication portion, the process moves to a register mode; electric power from the secondary battery is supplied to at least the charge/discharge control circuit 135, the memory of the authentication portion 109, and the memory of electric vehicle body and is not supplied to the electric motor portion. The data retained in the memory is information with lower rewrite frequency. Therefore a write-once ROM (Read Only Memory) may be used as the memory. As the memory, a known NOSRAM (Non-volatile Oxide Semiconductor Random Access Memory) may be used. As the memory, a known MRAM (Magnetoresistive Random Access Memory) utilizing MTJ (Magnetic Tunnel Junction) characteristics, a known ReRAM (Resistive Random Access Memory), or a known phase-change memory may be used.

The charge/discharge control circuit 135 illustrated in FIG. 3B is an example in which, unlike in FIG. 3A, a temperature sensor 20 is further included.

### <Voltage Measurement Circuit>

The voltage measurement circuit 15 is electrically connected to the positive electrode and the negative electrode of the battery 107 as illustrated in FIG. 3A and FIG. 3B. The voltage measurement circuit 15 may be electrically connected to the positive electrode terminal and the negative electrode terminal.

The voltage measurement circuit 15 has a function of measuring voltage of the battery 107 (referred to as a terminal voltage), and for example, has a function of measuring a terminal voltage (referred to as a charging voltage) when the battery 107 is being charged. The voltage measurement circuit 15 may have a function of measuring a terminal voltage (referred to as a discharging voltage) when the battery 107 is being discharged besides the charging voltage.

The voltage measurement circuit 15 can supply a measured voltage value to the control circuit 18. In the case where the measured voltage value is an analog value, the analog value may be converted to a digital value and supplied to the control circuit 18. In other words, the voltage measurement circuit 15 may include a circuit performing digital conversion of an analog value, and an analog/digital converter circuit (ADC) can be used as the circuit. Examples of a configuration of the ADC include a 42 modulation type, a parallel comparative type (also referred to as a flash type), and a pipeline type. The AZ modulation type has a high resolution and is suitable for the voltage measurement circuit 15.

### Measurement Example 1 of Voltage Vb1

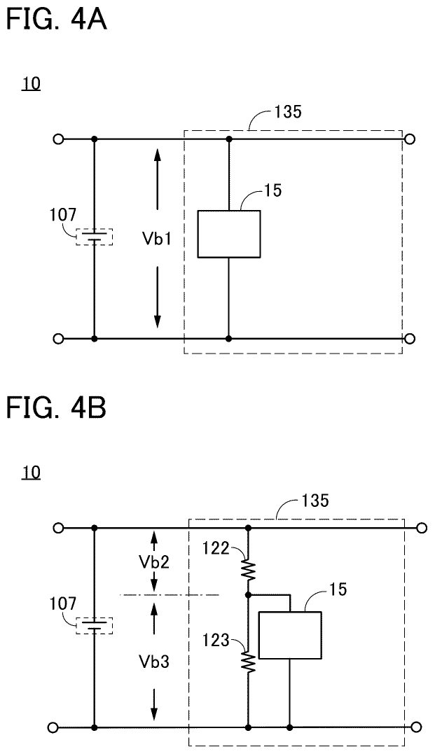

Measurement example 1 of a voltage Vb1 between the positive electrode and the negative electrode of the secondary battery is described with reference to FIG. 4A. Only the voltage measurement circuit 15 is illustrated in the charge/discharge control circuit 135 in FIG. 4A, and other components are omitted. As illustrated in FIG. 4A, the voltage measurement circuit 15 can directly measure the voltage Vb1 between the positive electrode and the negative electrode of the secondary battery.

### Measurement Example 2 of Voltage Vb1

As illustrated in FIG. 4B, the voltage measurement circuit 15 can measure the voltage Vb1 divided by resistors. Only the voltage measurement circuit 15 is illustrated in the charge/discharge control circuit 135 in FIG. 4B, and other components are omitted. In FIG. 4B, the voltage Vb1 is divided into a voltage Vb2 and a voltage Vb3 by a resistor 122 and a resistor 123, and the voltage measurement circuit 15 can measure the voltage Vb3, for example. In order to measure the voltage Vb3, the voltage measurement circuit 15 is electrically connected to the negative electrode of the battery 107 and a node between the resistor 122 and the resistor 123.

In the case where the voltage measurement circuit 15 measures voltages obtained by resistor division of the voltage between the positive electrode and the negative electrode of the battery 107, the voltage measurement circuit 15 or the control circuit 18 may estimate the voltage Vb1 between the positive electrode and the negative electrode of the battery 107 from the voltages obtained divided by resistors.

### <Current Measurement Circuit>

As illustrated in FIG. 3A and FIG. 3B, the current measurement circuit 16 is electrically connected to the positive electrode of the battery 107, a resistor is located between connection points, and a potential difference applied to the resistor is measured. Note that the current measurement circuit 16 may be electrically connected to the positive electrode terminal. There is no limitation on the current measurement circuit 16, and a hole-type current sensor may be used.

The current measurement circuit 16 has a function of measuring a current flowing between the positive electrode and the negative electrode of the battery 107, for example, preferably has a function of measuring a current (referred to as a charging current) when the battery 107 is being charged. The current measurement circuit 16 may have a function of measuring a current (referred to as a discharging current) when the battery 107 is being discharged besides the charging voltage.

The current measurement circuit 16 can supply a measured current value to the control circuit 18. Although the measured current value is an analog value, the analog value may be converted to a digital value and then supplied to the control circuit 18, and as an analog-digital converter circuit (ADC), the above-described one can be used.

### <Control Circuit>

The control circuit 18 illustrated in FIG. 3A and FIG. 3B has a function of controlling the start and stop of charge of the battery 107. Furthermore, the control circuit 18 preferably has an arithmetic function, a detection function, a determination function, or the like. As the arithmetic function, an arithmetic operation can be performed on data showing battery characteristics of the battery 107 from a value supplied from the voltage measurement circuit 15.

### <Determination Function>

With the determination function of the control circuit 18, the case where charge should be stopped can be determined on the basis of the signal obtained from the authentication portion 109.

### <Stop Charge and Discharge>

The control circuit 18 has a function of stopping charge and discharge on the basis of the signal obtained from the authentication portion 109.

### <Charging Condition>

Constant current-constant voltage charging (CC-CV charging) is employed for charging of a secondary battery in some case. In CC-CV charging, constant current charging is performed up to the upper limit voltage of charging, and then, constant voltage charging is performed.

The charging condition from the start of charging to the stop of charging is preferably constant current charging. For example, in the case of the constant current charging period, charge is stopped and then a voltage is changed after restarting, and thus the SOC (charge rate) can be easily grasped.

### <Coulomb Counter>

The charge/discharge control circuit 135 preferably has a function of a coulomb counter. For example, as a function of a coulomb counter, the charge/discharge control circuit 135 can calculate the integrated quantity of electricity of the battery 107 by using the current measurement circuit 16 and the control circuit 18. With the calculated quantity of electricity, the charge capacity and the discharge capacity of the secondary battery can be calculated.

### <SOC>

The control circuit 18 may have a function of analyzing the SOC using the calculated charge capacity and discharge capacity. As the control circuit 18, a CPU (central processing unit) or an MCU (Micro Controller Unit) can be used.

The control circuit 18 preferably includes a memory circuit 19 in addition to the CPU or the MCU. The memory circuit 19 can also store a piece of encryption data (corresponding to the first identification number 202a described in Embodiment 1) on the battery used for authentication in the authentication portion 109.

### <Temperature Sensor>

The temperature sensor 20 illustrated in FIG. 3B can measure the operating temperature of the secondary battery. The temperature sensor 20 measures temperatures in a range from a low temperature to a high temperature. The temperature sensor 20 is preferably placed in contact with an exterior body of the battery 107 or a housing outside the exterior body.

In the case where the battery 107 is used at a low temperature and a high temperature, a low temperature and room temperature, or different operating temperatures, information on the operating temperature obtained from the temperature sensor 20 is useful. Even when the battery 107 is used in the range of the same temperature, abnormality that occurs in the battery can also be detected by the temperature sensor 20. In the case where the safety of the material of the secondary battery is high, the temperature sensor 20 is not necessarily provided.

### <Secondary Battery>

The details of the battery 107 are described later.

### <Assembled Battery>

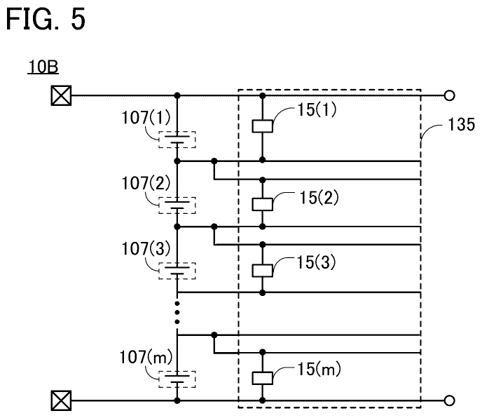

The battery management system 10B illustrated in FIG. 5 is an example in which the charge/discharge control circuit 135 is electrically connected to m batteries 107 connected in series (m is a positive integer). FIG. 5 illustrates an example of the battery management system 10B where m is a natural number greater than or equal to 4, and among m batteries 107, a battery 107 (1), a battery 107 (2), a battery 107 (3), and a battery 107 (m) are illustrated as first, second, third, and m-th batteries. The charge/discharge control circuit 135 may be divided into m charge/discharge control circuits 135 (m), but is preferably shared as in FIG. 5.

In the battery management system 10B, voltages of the m batteries 107 can be measured with m voltage measurement circuits 15 connected to the respective batteries. The voltage measurement circuit 15 may be shared instead of being divided into m voltage measurement circuits 15 as illustrated in FIG. 5. The total voltages of the m batteries 107 connected in series (e.g., a voltage between the positive electrode of the battery 107 (1) and the negative electrode of the battery 107 (m) in FIG. 5) may be used for voltage measurement.

At least part of this embodiment can be implemented in combination with the other embodiments described in this specification as appropriate.

### Embodiment 3

### [Cylindrical Secondary Battery]

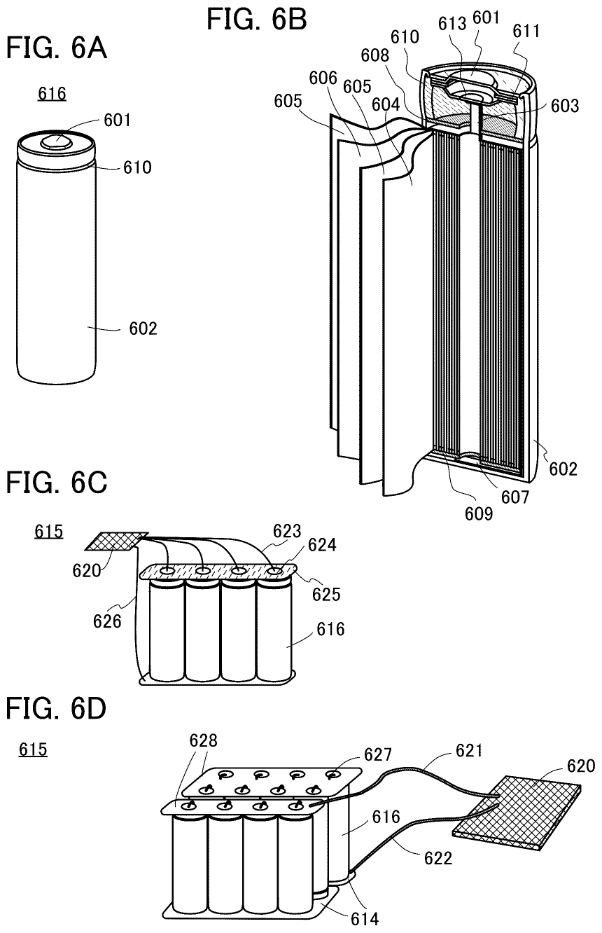

An example of a cylindrical secondary battery is described with reference to FIG. 6A. As illustrated in FIG. 6A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 6B schematically illustrates a cross section of a cylindrical secondary battery. The cylindrical secondary battery illustrated in FIG. 6B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a wound body in which a belt-like positive electrode 604 and a belt-like negative electrode 606 are wound with a belt-like separator 605 located therebetween is provided. Although not illustrated, the wound body is wound around a central axis. One end of the battery can 602 is closed and the other end thereof is opened. For the battery can 602, a metal having corrosion resistance to a liquid electrolyte, typified by nickel, aluminum, or titanium, an alloy of such a metal, and an alloy of such a metal and another metal (e.g., stainless steel) can be used. The battery can 602 is preferably covered with nickel or aluminum in order to prevent corrosion due to the liquid electrolyte. Inside the battery can 602, the wound body in which the positive electrode, the negative electrode, and the separator are wound is provided between a pair of insulating plates 608 and 609 that face each other. A nonaqueous electrolyte solution (not illustrated) is injected inside the battery can 602 provided with the wound body.

Since a positive electrode and a negative electrode that are used for a cylindrical storage battery are wound, active materials are preferably formed on both surfaces of a current collector. Note that although FIG. 6A to FIG. 6D each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material of aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC (Positive Temperature Coefficient) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic can be used for the PTC element.

FIG. 6C illustrates an example of a battery management system 615. The battery management system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharge or overdischarge can be used.

FIG. 6D illustrates an example of the battery management system 615. The battery management system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the battery management system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the battery management system 615 is less likely to be influenced by the outside temperature.

In FIG. 6D, the battery management system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

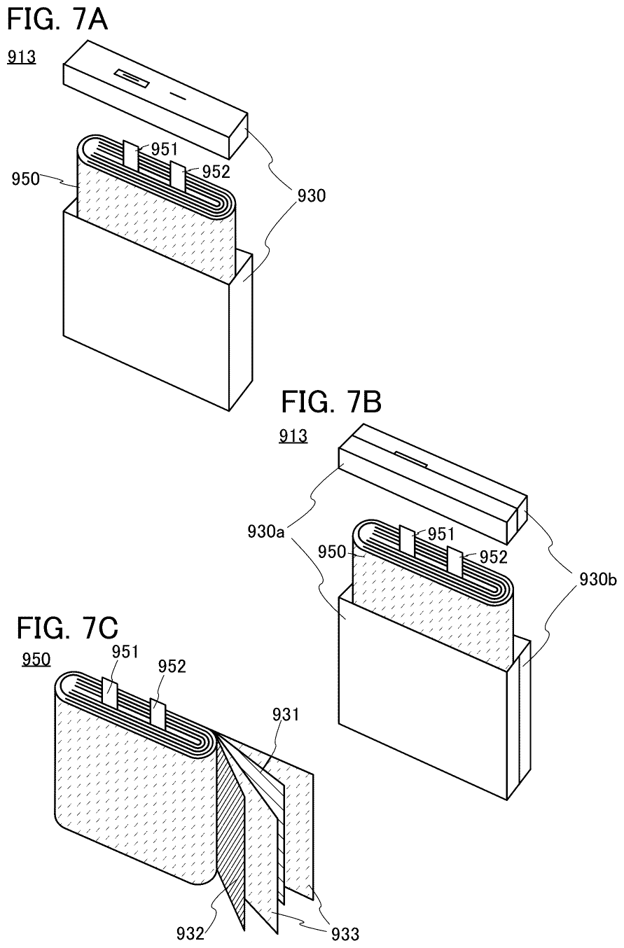

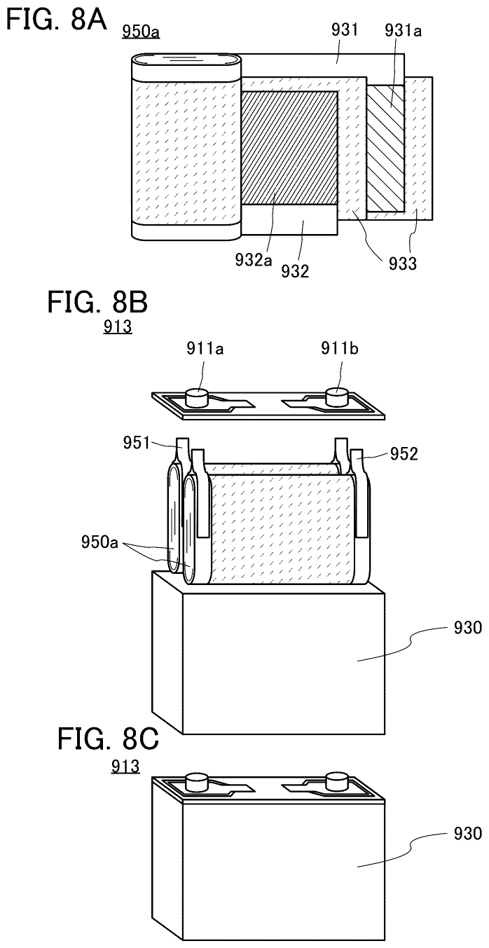

Structure examples of secondary batteries are described with reference to FIG. 7 and FIG. 8.

A secondary battery 913 illustrated in FIG. 7A includes a wound body 950 provided with a terminal 951 and a terminal 952 inside a housing 930. The wound body 950 is immersed in a liquid electrolyte inside the housing 930. The terminal 952 is in contact with the housing 930. The use of an insulator inhibits contact between the terminal 951 and the housing 930. Note that in FIG. 7A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 7B, the housing 930 illustrated in FIG. 7A may be formed using a plurality of materials. For example, in the secondary battery 913 illustrated in FIG. 7B, a housing 930a and a housing 930b are attached to each other, and the wound body 950 is provided in a region surrounded by the housing 930a and the housing 930b.

For the housing 930a, an insulating material typified by an organic resin can be used. In particular, when a material typified by an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 7C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 8A to FIG. 8C, the secondary battery 913 may include a wound body 950a. The wound body 950a illustrated in FIG. 8A includes the negative electrode 931, the positive electrode 932, and the separators 933. The negative electrode 931 includes a negative electrode active material layer 931a. The positive electrode 932 includes a positive electrode active material layer 932a.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 8B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 8C, the wound body 950a and a liquid electrolyte are covered with the housing 930, whereby the secondary battery 913 is completed. The housing 930 is preferably provided with a safety valve and an overcurrent protection element. In order to prevent the battery from exploding, a safety valve is a valve to be released when the internal pressure of the housing 930 reaches a predetermined pressure.

As illustrated in FIG. 8B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 7A to FIG. 7C can be referred to for the other components of the secondary battery 913 illustrated in FIG. 8A and FIG. 8B.

### <Laminated Secondary Battery>

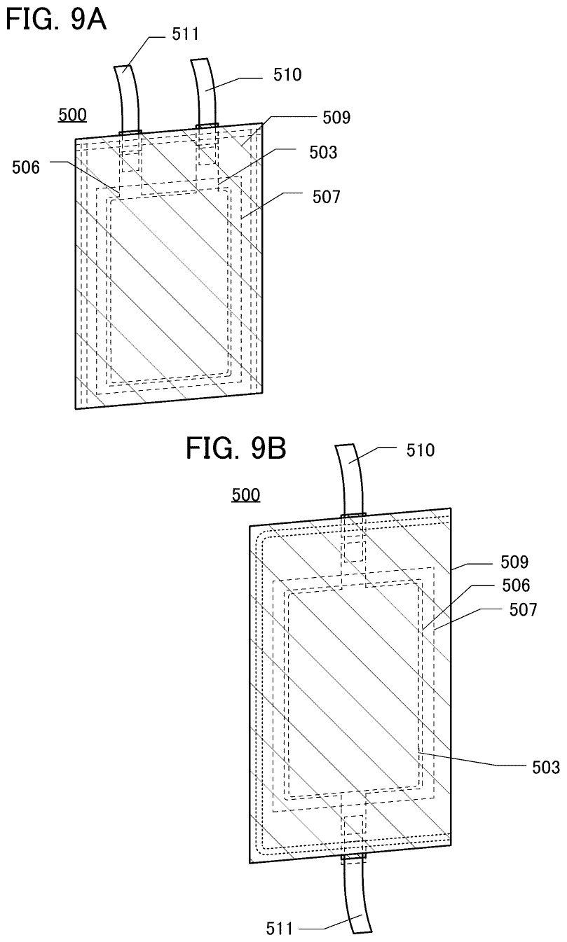

Next, examples of the appearance of a laminated secondary battery are illustrated in FIG. 9A and FIG. 9B. In FIG. 9A and FIG. 9B, a positive electrode 503, a negative electrode 506, a separator 507, an exterior body 509, a positive electrode lead electrode 510, and a negative electrode lead electrode 511 are included.

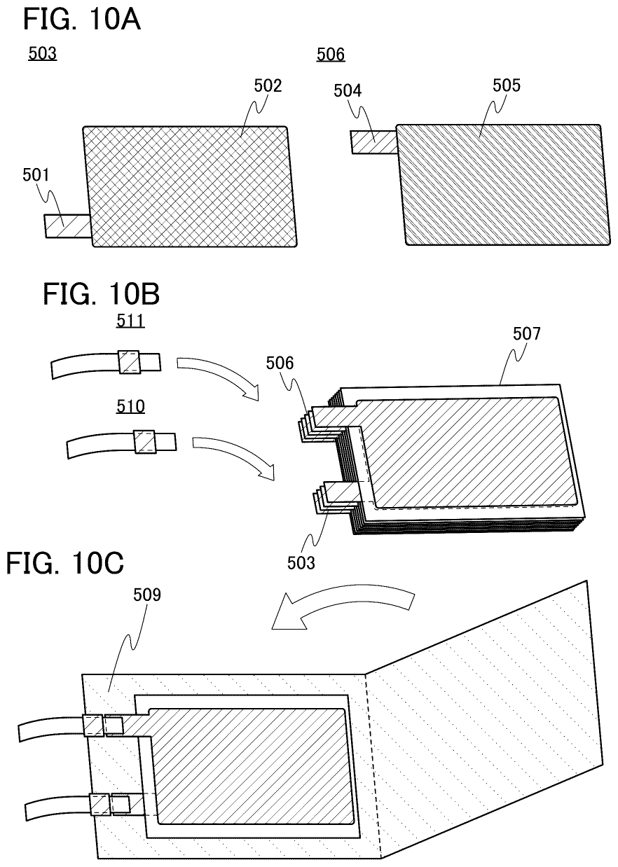

FIG. 10A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples illustrated in FIG. 10A.

### <Method for Fabricating Laminated Secondary Battery>

Here, an example of a method for fabricating the laminated secondary battery whose external view is shown in FIG. 9A is described with reference to FIG. 10B and FIG. 10C.

First, the negative electrode 506, the separator 507, and the positive electrode 503 are stacked. FIG. 10B illustrates the negative electrodes 506, the separators 507, and the positive electrodes 503 that are stacked. Here, an example in which five negative electrodes and four positive electrodes are used is shown. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion shown by a dashed line, as illustrated in FIG. 10C. Then, the outer edges of the exterior body 509 are bonded to each other. The bonding can be performed by thermocompression, for example. At this time, an unbonded region (hereinafter, referred to as an inlet) is provided for part (or one side) of the exterior body 509 so that a liquid electrolyte can be introduced later.

Next, the liquid electrolyte (not illustrated) is introduced into the exterior body 509 from the inlet of the exterior body 509. The liquid electrolyte is preferably introduced in a reduced pressure atmosphere or in an inert atmosphere. Lastly, the inlet is sealed by bonding. In this manner, the laminated secondary battery 500 can be fabricated.

### Embodiment 4

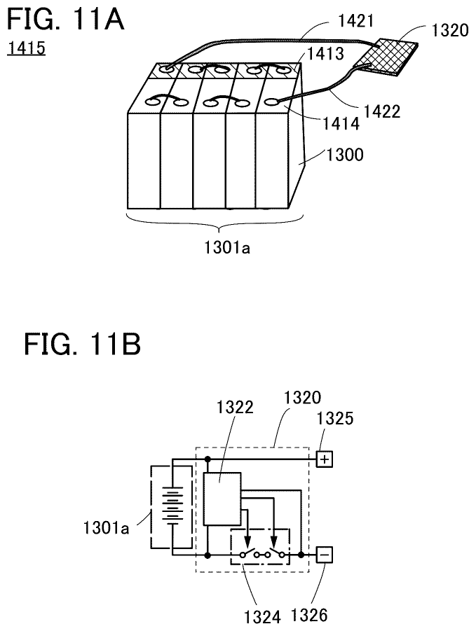

This embodiment shows an example different from the cylindrical secondary battery in FIG. 6D. An example in which the secondary battery illustrated in FIG. 11A is applied to an electrically assisted bicycle or an electric motorcycle is described.

The internal structure of the battery used in an electrically assisted bicycle or an electric motorcycle may be a wound structure illustrated in FIG. 7A or FIG. 8C or a stacked-layer structure illustrated in FIG. 9A or FIG. 9B. As the battery, an all-solid-state battery may be used. The use of the all-solid-state battery as the battery can achieve high capacity, improvement in safety, and reduction in size and weight.

A plurality of batteries are not necessarily prepared as long as a sufficient amount of electric power can be stored in one battery. By constituting a battery pack including a plurality of batteries, large electric power can be extracted. The plurality of batteries may be connected in parallel, connected in series, or connected in series after being connected in parallel. The plurality of batteries are also referred to as an assembled battery.

Electric power of the battery is mainly used to rotate a motor.

In addition, the battery supplies electric power to an in-vehicle component (an audio device or a lamp) for 14 V through a DCDC circuit. The DCDC circuit may be formed using, for example, a transistor including Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), or GaOx (gallium oxide, where x is a real number greater than 0) without being limited to a Si (silicon) transistor using single crystal silicon. Alternatively, a high-electron-mobility transistor (HEMT) may be used as the transistor used for the DCDC circuit. As a material used for the HEMT, any one or more selected from GaAs, InP, GaN, or SiGe can be used, for example.

The battery is described with reference to FIG. 11A.

FIG. 11A illustrates an example in which five rectangular secondary batteries 1300 form one battery pack 1415. The five rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (a road surface), the plurality of secondary batteries are preferably fixed by the fixing portions 1413 and 1414 and a battery container box. Furthermore, the one electrode is electrically connected to a control circuit portion 1320 through a wiring 1421. The other electrode is electrically connected to the control circuit portion 1320 through a wiring 1422.

FIG. 11B illustrates an example of a block diagram of the battery pack 1415 illustrated in FIG. 11A.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the battery 1301a. The control circuit portion 1320 is set to have the upper limit voltage and the lower limit voltage of the secondary battery to be used, and imposes the upper limit of current from the outside and the upper limit of output current to the outside. The voltage in the range of the lower limit voltage to the upper limit voltage inclusive of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarge and overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in a position of the middle of the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to a switch including a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), or GaOx (gallium oxide, where x is a real number greater than 0).

Regenerative energy generated by rotation of tires is transmitted to the motor through a gear, and transferred from a motor controller through the control circuit portion to be stored in the battery.

Although not illustrated, in the case of connecting an electric vehicle to an external charger, a plug of the charger or a connection cable of the charger is electrically connected to the control circuit portion 1320. Electric power supplied from the external charger is stored in the battery 1301a through the control circuit portion 1320. Some chargers are provided with a control circuit, in which case the function of the control circuit portion 1320 is not used; to prevent overcharge, the battery 1301a is preferably charged through the control circuit portion 1320. The plug of the charger or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. A communication standard referred to as a CAN-FD that can be encrypted may be used. The ECU includes a microcomputer. Moreover, the ECU uses a CPU or a GPU.

External chargers installed at charge stations have a 100 V outlet, a 200 V outlet, or a three-phase 200 V outlet with 50 kW. Furthermore, charge can be performed with electric power supplied from external charge equipment by a contactless power feeding method.

For fast charge, secondary batteries that can withstand high-voltage charge have been desired to perform charge in a short time.

The contents of this embodiment can be combined with the contents of the other embodiments as appropriate.

### Embodiment 5

In this embodiment, examples in which a motorcycle or a bicycle is provided with the antitheft system of one embodiment of the present invention will be described.

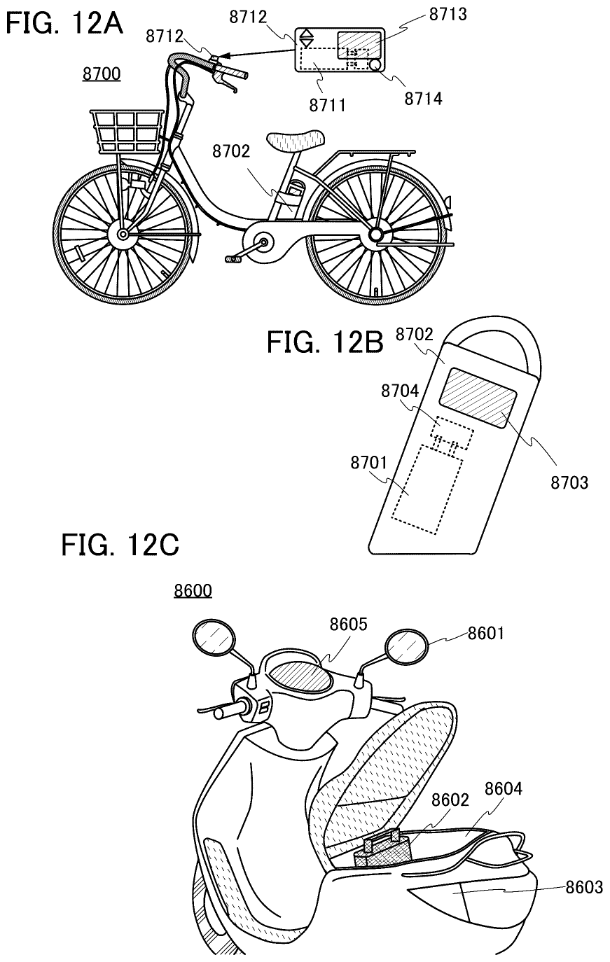

FIG. 12A is an example of an electric bicycle using the antitheft system of one embodiment of the present invention. The antitheft system of one embodiment of the present invention can be used for an electric bicycle 8700 illustrated in FIG. 12A. The power storage device of one embodiment of the present invention includes a plurality of batteries, a charge/discharge control portion, and an authentication portion, for example.

The electric bicycle 8700 includes a power storage device 8702. The power storage device 8702 can supply electricity to a motor (an electric motor portion) that assists a rider. The power storage device 8702 is portable, and the power storage device 8702 in FIG. 12B is detached from the bicycle and corresponds to the secondary battery unit. A plurality of batteries 8701 are incorporated in the power storage device 8702, and the remaining battery capacity can be displayed on a display portion 8703. In the case where authentication by the authentication portion fails and the process moves to the theft mode, “the stolen battery” is displayed on the display portion 8703. The power storage device 8702 includes a charge/discharge control circuit 8704 capable of charge control or anomaly detection for the secondary battery. The charge/discharge control circuit 8704 is electrically connected to a positive electrode and a negative electrode of the battery 8701. In addition, a steering wheel of the electric bicycle 8700 is provided with an operation portion 8712. The operation portion 8712 includes a display portion 8713, a power switch 8714, and a power storage device 8711. The charge/discharge control portion 8704 may include a memory portion capable of storing encryption data.

FIG. 12C illustrates an example of a motorcycle using the antitheft system of one embodiment of the present invention. A motor scooter 8600 illustrated in FIG. 12C includes a secondary battery unit 8602, side mirrors 8601, indicator lights 8603, and a display portion 8605. The secondary battery unit 8602 can supply electricity to the indicator lights 8603.

Furthermore, in a motor scooter 8600 illustrated in FIG. 12C, a secondary battery unit 8602 can be stored in an under-seat storage 8604. The secondary battery unit 8602 can be stored in the under-seat storage 8604 even when the under-seat storage 8604 is small. The secondary battery unit can be attached to and detached from the main body of the motor scooter 8600.

The secondary battery unit 8602 includes an authentication portion, a wireless communication portion, and a first memory portion in addition to the secondary battery and the charge/discharge control portion. The first memory portion can store encryption data corresponding to the production number of the secondary battery.

The main body of the motor scooter 8600 includes a second memory portion, and encryption data corresponding to the vehicle number (body number) can be stored. In the motor scooter 8600, the electric motor is also marked with the production number, and the number may be used for the antitheft system of one embodiment of the present invention.

When the motor scooter 8600 starts running, the authentication portion of the secondary battery unit 8602 can collate data in the first memory portion and the second memory portion to determine whether the secondary battery unit 8602 is a stolen article. In the case of a failure in the authentication, electric power supply from the secondary battery unit 8602 to the electric motor is stopped, so that the motor scooter 8600 becomes prevented from running. In the case of a failure in the authentication, the secondary battery unit 8602 may be discharged to be non-functional.

The wireless communication portion may be provided also in the body unit of the motor scooter 8600; the vehicle number (body number) of the motor scooter 8600 may be displayed on the display portion 8605, and authentication may be performed with the user's information terminal through the wireless communication portion of the body unit of the motor scooter 8600. In this case, authentication of the body unit of the motor scooter 8600 and the secondary battery unit 8602 can each be performed with the user's information terminal.

The contents of this embodiment can be combined with the contents of the other embodiments as appropriate.

### REFERENCE NUMERALS

10: battery management system, 10B: battery management system, 15: voltage measurement circuit, 16: current measurement circuit, 18: control circuit, 19: memory circuit, 20: temperature sensor, 35: switch, 36: switch, 40: terminal, 107: battery, 109: authentication portion, 122: resistor, 123: resistor, 135: charge/discharge control circuit, 200: secondary battery, 201: electric motor portion, 202a: identification number, 202b: identification number, 203: charge/discharge control portion, 204: memory portion, 207: operation portion, 208: display portion, 209: power switch, 210: secondary battery unit, 213: wireless communication portion, 214: memory portion, 215: authentication portion, 220: electric vehicle body unit, 250: user, 251: personal identification information, 252: information terminal, 253: wireless communication portion, 254: memory portion, 260: server device, 261: encryption data generation program, 263: wireless communication portion, 264: memory portion, 500: secondary battery, 501: positive electrode current collector, 502: positive electrode active material layer, 503: positive electrode, 504: negative electrode current collector, 505: negative electrode active material layer, 506: negative electrode, 507: separator, 509: exterior body, 510: positive electrode lead electrode, 511: negative electrode lead electrode, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 613: safety valve mechanism, 614: conductive plate, 615: battery management system, 616: secondary battery, 620: control circuit, 621: wiring, 622: wiring, 623: wiring, 624: conductor, 625: insulator, 626: wiring, 627: wiring, 628: conductive plate, 911a: terminal, 911b: terminal, 913: secondary battery, 930: housing, 930a: housing, 930b: housing, 931: negative electrode, 931a: negative electrode active material layer, 932: positive electrode, 932a: positive electrode active material layer, 933: separator, 950: wound body, 950a: wound body, 951: terminal, 952: terminal, 1200: secondary battery, 1201: electric motor portion, 1203: charge/discharge control portion, 1207: operation unit, 1208: display portion, 1209: power switch, 1210: secondary battery unit, 1220: electric vehicle body unit, 1300: rectangular secondary battery, 1301a: battery, 1320: control circuit portion, 1322: control circuit, 1324: switch portion, 1325: external terminal, 1326: external terminal, 1413: fixing portion, 1414: fixing portion, 1415: battery pack, 1421: wiring, 1422: wiring, 8600: motor scooter, 8601: side mirror, 8602: secondary battery unit, 8603: indicator light, 8604: under-seat storage unit, 8605: display portion, 8700: electric bicycle, 8701: battery, 8702: power storage device, 8703: display portion, 8704: charge/discharge control portion, 8711: power storage device, 8712: operation portion, 8713: display portion, 8714: power switch

1. An electric vehicle comprising:
an electric vehicle body unit comprising an electric motor portion; and
a secondary battery unit capable of being attached to and detached from the electric vehicle body unit,
wherein the secondary battery unit comprises a first memory portion storing first identification information,
wherein the electric vehicle body unit comprises a second memory portion storing second identification information, and
wherein the secondary battery unit comprises an authentication portion collating the first identification information and the second identification information, and a wireless communication portion receiving the first identification information and the second identification information.

2. The electric vehicle according to claim 1,
wherein the secondary battery unit further comprises a secondary battery and a charge/discharge control portion electrically connected to the secondary battery, and electric power is supplied to the electric motor portion on the basis of a signal from the authentication portion.

3. The electric vehicle according to claim 1,
wherein the first identification information and the second identification information are transmitted from an information terminal of a user to the wireless communication portion.

4. The electric vehicle according to claim 1,
wherein the electric vehicle is an electrically assisted bicycle or an electric motorcycle.

5. An antitheft system of a secondary battery, comprising:
an electric vehicle body unit comprising an electric motor portion;
a secondary battery unit capable of being attached to and detached from the electric vehicle body unit; and
a server device that generates, registers, and manages first identification information and second identification information,
wherein the secondary battery unit comprises a first memory portion storing the first identification information, a wireless communication portion that can communicate with an information terminal of a user, and an authentication portion,
wherein the electric vehicle body unit comprises a second memory portion storing the second identification information, and
wherein after collating the first identification information and the second identification information, output from the secondary battery unit to the electric motor portion is allowed when authentication by the authentication portion succeeds, or output from the secondary battery unit to the electric motor portion is stopped when the authentication fails.

6. The antitheft system of a secondary battery, according to claim 5,
wherein the server device generates the first identification information and the second identification information on the basis of user information, a production number of the secondary battery unit, or a production number of the electric vehicle body unit.

7. The antitheft system of a secondary battery, according to claim 5,
wherein a state where the secondary battery unit is stolen is displayed or the secondary battery is made non-functional when the authentication fails.

8. The antitheft system of a secondary battery, according to claim 5,
wherein the first identification information and the second identification information are the same.

9. The antitheft system of a secondary battery, according to claim 5,
wherein the first identification information and the second identification information are each encryption data.
